(19) United States
(12) Patent Application Publication
(10) Pub. No.: US 2013/0337704 A1
(43) Pub. Date: Dec. 19, 2013

(54) CONNECTOR

(71) Applicants: Naokazu Nagasaka, Makinohara-shi (JP); Takumi Nakagishi, Makinohara-shi (JP)

(72) Inventors: Naokazu Nagasaka, Makinohara-shi (JP); Takumi Nakagishi, Makinohara-shi (JP)

(73) Assignee: YAZAKI CORPORATION, Tokyo (JP)

(21) Appl. No.: 14/002,300

(22) PCT Filed: Mar. 5, 2012
(86) PCT No.: PCT/JP2012/055509

§ 371 Date: Aug. 29, 2013

(30) Foreign Application Priority Data
Mar. 8, 2011 (JP) 2011-050089

(51) Int. Cl. H01R 13/11

(52) U.S. Cl. CPC H01R 13/11
USPC 439/877

(57) ABSTRACT

Provide is a connector which can improve production efficiency and retention strength of a lance of a terminal receiving portion on a terminal fitting. A terminal fitting includes an electric wire connection portion, an electrical contact portion connected to a mating terminal fitting and a tube portion provided between the electric wire connection portion and the electrical contact portion, and a housing includes a terminal receiving portion. The housing has a lance having one end continued to an inner face of the terminal receiving portion and the other end being a free end and extending toward the tube portion. The tube portion includes an opening portion. An engagement portion engaging with the free end is provided to an edge of the opening portion adjacent to the electrical contact portion so as to project from the edge of the opening portion toward an inner side of the tube portion.

### TECHNICAL FIELD

The present invention relates to connector including a terminal fitting and a housing having a terminal receiving portion arranged to receive the terminal fitting.

### BACKGROUND ART

An automobile as a moving body is mounted with various electronic devices. A wire harness is used to transmit electric power and a control signal and such to these electronic devices. The wire harness includes a plurality of electric wires and a connector. The connector includes a terminal fitting to be attached to an end of the electric wire and a housing having a plurality of terminal receiving portions arranged to receive the terminal fittings (for example, refer to Patent Literature 1). FIG. 7 is a cross sectional view showing a conventional connector disclosed in Patent Literature 1. FIG. 8 is a perspective view showing a portion of a terminal fitting constituting the connector shown in FIG. 7.

As shown in FIGS. 7-8, the terminal fitting 102 includes an electric wire connection portion 103 connected to an electric wire 7, an electrical contact portion 105 continued to the electric wire connection portion 103 and connected to a mating terminal fitting, and an engagement portion 145 provided to the electrical contact portion 105. The terminal fitting 102 is inserted into a terminal receiving portion 161 along its longitudinal direction N. Then, the engagement portion 145 of the terminal fitting 102 is engaged with a lance 165 of the terminal receiving portion 161, and the terminal fitting 102 is received in the terminal receiving portion 161. Once the engagement portion 145 is engaged with the lance 165, the terminal fitting 102 connected to the electric wire 7 is prevented from being removed out from the terminal receiving portion 161 when the electric wire 7 is pulled.

The engagement portion 145 is arranged so as to project from the electrical contact portion 105 toward the lance 165 of the terminal receiving portion 161. That is, the engagement portion 145 is arranged so as to project from the electrical contact portion 105 in an outward direction.

Furthermore, the engagement portion 145 includes an engagement projection 146 and an inward projection 147. The engagement projection 146 is formed by hammering out an outer wall 105a constituting the electrical contact portion 105 in the outward direction of the electrical contact portion 105 so that the side of the engagement portion 145 adjacent to the electric wire connection portion 103 is opened. The inward projection 147 is formed by hammering out a part of the engagement projection 146 in an inward direction of the electrical contact portion 105. Thus, this engagement portion 145 is formed by firstly forming the engagement projection 146 by hammering out the outer wall 105a of the electrical contact portion 105 in the outward direction, and then forming the inward projection 147 by hammering out the engagement projection 146 in the inward direction.

The terminal receiving portion 161 includes the lance 165 having one end continued to an inner face of the terminal receiving portion 161 and the other end being a free end. The lance 165 is provided at a center of the terminal receiving portion 161 in a widthwise direction. The dimension along the widthwise direction of the lance 165 is formed to be smaller than the dimension L along the widthwise direction of the inward projection 147 provided to the terminal fitting 102.

The conventional connector 101 having the above-described configuration includes the engagement portion 145 provided with the engagement projection 146 formed by hammering out the outer wall 105a of the electrical contact portion 105 in the outward direction and the inward projection 147 formed by hammering out the engagement projection 146 in the inward direction. Thus, a dimension T3, which is the sum of a dimension T1 of the engagement projection 146 hammered out in the outward direction and a dimension T2 of the inward projection 147 hammered out in the inward direction, corresponds to an engagement portion at which the engagement portion 145 engages with the lance 165. Thus, in the conventional connector 101, the retention strength of the lance 165 on the terminal fitting 102 is increased by increasing the engagement portion of the engagement portion 145, i.e. the dimension T3.

### CITATION LIST

### Patent Literature

Patent Literature 1: Japan Patent Application Publication No. 2004-47227

### SUMMARY OF INVENTION

### Problem to be Solved

However, the conventional connector 101 described above has a problem as described below. That is, the engagement portion 145 provided to the terminal fitting 102 of the connector 101 is formed by firstly hammering out the outer wall 105a of the electrical contact portion 105 in the outward direction to form the engagement projection 146, and then hammering out the engagement projection 146 in the inward direction to form the inward projection 147, causing the formation of a recess 147′ which is concave with respect to the outer surface of the engagement projection 146. Due to this formation of the recess 147′, the area of contact between the engagement portion 145 and the lance 165 is reduced, thereby causing a problem that the retention strength of the lance 165 on the terminal fitting 102 is reduced. Furthermore, since the engagement portion 145 is formed by firstly hammering out the outer wall 105a of the electrical contact portion 105 in the outward direction to form the engagement projection 146 and then hammering out the engagement projection 146 in the inward direction to form the inward projection 147, it requires a lot of work to form the terminal fitting 102, increasing the time need to manufacture the connector 101 and possibly lowering the production efficiency.

The present invention aims to solve the above-mentioned problem. Thus, an object of the present invention is to provide a connector which can improve the retention strength of a lance of a terminal receiving portion on a terminal fitting while improving the production efficiency.

### Solution to Problem

In order to achieve the above-described object, the present invention provides, in a first aspect, a connector including: a terminal fitting including an electric wire connection portion arranged to be connected to an electric wire, an electrical contact portion arranged to be connected to a mating terminal fitting, and a tube portion provided between the electric wire connection portion and the electrical contact portion; and a housing including a terminal receiving portion arranged to receive the terminal fitting, wherein the housing is provided with a lance having one end continued to an inner face of the terminal receiving portion and the other end being a free end and extending toward the tube portion of the terminal fitting, wherein an opening portion is formed at the tube portion, wherein an engagement portion which engages with the free end of the lance is provided to an edge of the opening portion adjacent to the electrical contact portion, and wherein the engagement portion is arranged to project from the edge of the opening portion toward an inner side of the tube portion.

In order to achieve the above-described object, the present invention provides, in a second aspect, the connector mentioned above wherein the engagement portion is formed by bending a part of an outer wall of the tube portion toward the inner side of the tube portion.

In order to achieve the above-described object, the present invention provides, in a third aspect, the connector mentioned above, wherein a surface of the engagement portion is indented.

Advantageous Effects of Invention

As explained above, according to the invention described in the first aspect, there are provided the terminal fitting including the electric wire connection portion arranged to be connected to the electric wire, the electrical contact portion arranged to be connected to the mating terminal fitting, and the tube portion provided between the electric wire connection portion and the electrical contact portion, and the housing including a terminal receiving portion arranged to receive the terminal fitting, wherein the housing is provided with the lance having one end continued to the inner face of the terminal receiving portion and the other end being the free end and extending toward the tube portion of the terminal fitting, wherein the opening portion is formed at the tube portion, and wherein the engagement portion which engages with the free end of the lance is provided to the edge of the opening portion adjacent to the electrical contact portion. The engagement portion is arranged to project from the edge of the opening portion toward the inner side of the tube portion, thereby increasing the area of contact between the engagement portion and the lance and improving the retention strength of the lance provided to the terminal receiving portion on the terminal fitting.

According to the invention described in the second aspect, the engagement portion is formed by bending a part of the outer wall of the tube portion toward the inner side of the tube portion. Thus, the work for manufacturing the terminal fitting can be reduced, thereby reducing the time required to manufacture the connector and improving the production efficiency.

According to the invention described in the third aspect, the surface of the engagement portion is indented. Thus, the frictional resistance on the surface of the engagement portion is increased, thereby making the engagement portion less likely to slidably move with respect to the free end of the lance and further improving the retention strength of the lance provided to the terminal receiving portion on the terminal fitting.

### BRIEF DESCRIPTION OF DRAWINGS

FIG. 1 is a cross sectional view showing a connector according to one embodiment of the present invention;

FIG. 2 is a perspective view showing a terminal fitting constituting the connector of FIG. 1;

FIG. 3 is a cross sectional view taken along the line I-I shown in FIG. 2;

FIG. 4 is a cross sectional view taken along the line II-II shown in FIG. 3;

FIG. 5 is a cross sectional view showing a modified embodiment of the terminal fitting shown in FIG. 2;

FIG. 6 is a cross sectional view showing another modified embodiment of the terminal fitting shown in FIG. 5;

FIG. 7 is a cross sectional view of a conventional connector; and

FIG. 8 is a perspective view showing a part of the terminal fitting constituting the connector of FIG. 7.

### DESCRIPTION OF EXEMPLARY EMBODIMENTS

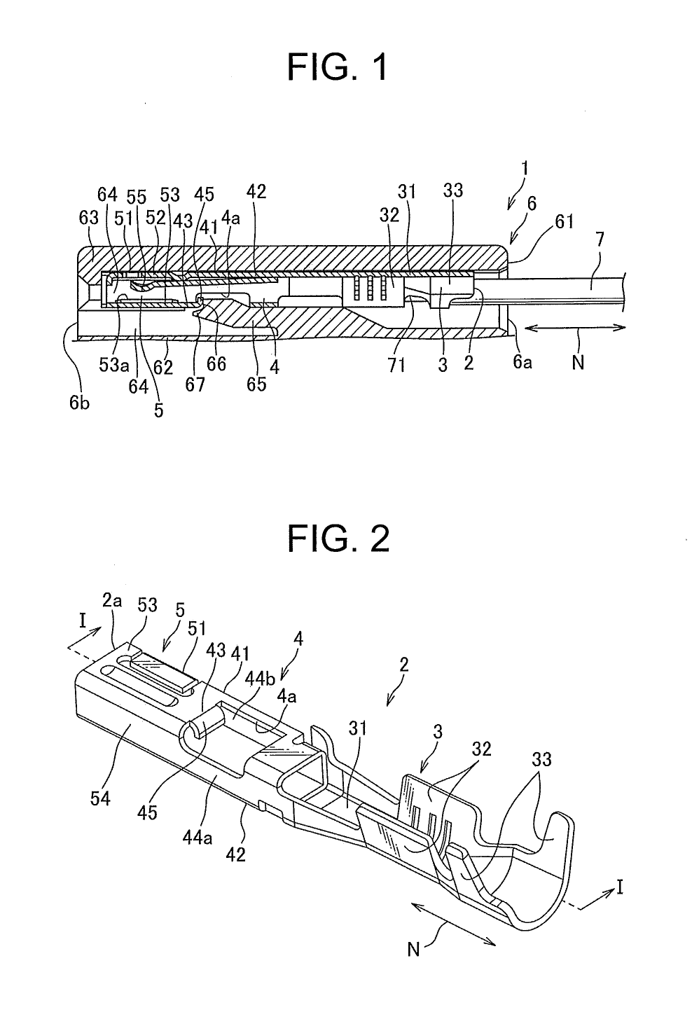

In the following, a connector according to one embodiment of the present invention is explained in reference to FIGS. 1 through 4.

A connector 1 constitutes a wire harness which is wired to an automobile. As shown in FIG. 1, the connector 1 includes a terminal fitting 2 attached to an end of an electric wire 7 constituting the wire harness and a housing 6 including a terminal receiving portion 61 arranged to receive the terminal fitting 2.

The terminal fitting 2 is obtained by bending a conductive metal plate. As shown in FIGS. 2 through 4, the terminal fitting 2 includes an electric wire connection portion 3 arranged to be connected to an electric wire 7, a housing mount portion 4 continued to the electric wire connection portion 3 and arranged to engage with a later-described lance 65 provided to a terminal receiving portion 61, and an electrical contact portion 5 continued to the housing mount portion 4 and arranged to be connected to a mating terminal fitting. While the electric wire connection portion 3 is connected to the electric wire 7, the terminal fitting 2 is inserted into the terminal receiving portion 61 of the housing 6 from a side of the electrical contact portion 5. The terminal fitting 2 is inserted into the terminal receiving portion 61 along a longitudinal direction N of the terminal fitting 2.

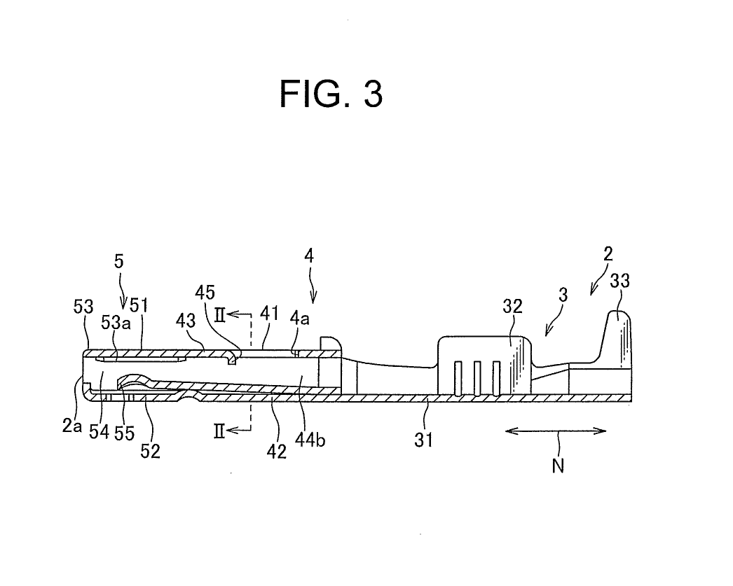

As shown in FIGS. 2 and 3, the electric wire connection portion 3 includes a base wall 31 arranged to position the electric wire 7 on its surface, a pair of core wire crimping pieces 32 arranged to extend upward from both widthwise ends of the base wall 31 to crimp a core wire 71 of the electric wire 7, and a pair of insulating cover crimping pieces 33 extending upward from both widthwise ends of the base wall 31 to crimp the insulating cover of the electric wire 7.

The electric wire connection portion 3 is electrically connected to the electric wire 7 by firstly placing, on the base wall 31, the electric wire 7 having a circular cross section and having the core wire 71 which is exposed by removing the cover at an end portion of the electric wire 7, and then bending the core wire crimping pieces 32 so as to push the core wire 71 of the electric wire 7 against the base wall 31, i.e. so as to fix in a crimping fashion the core wire 71 of the electric wire 7 using the core wire crimping pieces 32. Similarly, the insulating cover crimping pieces 33 are bent so as to push the covered portion of the electric wire 7 against the base wall 31, i.e. so as to fix in a crimping fashion the insulating covered portion of the electric wire 7 to the electric wire 7. FIGS. 2 and 3 show a state before the electric wire is fixed by the core wire crimping pieces 32 and the insulating cover crimping pieces 33.

As shown in FIGS. 2 and 3, the housing mount portion 4 includes a first tube portion 41 formed into a hollow rectangular column-like shape with a base wall 42 continued to the base wall 31, a first opposing wall 43 arranged with a space from the base wall 42 and a pair of side walls 44a connecting both widthwise ends of the base wall 42 and the first opposing wall 43 to each other. The housing mount portion 4 further includes an engagement portion 45 arranged to engage with the lance 65 provided to the terminal receiving portion 61. In other words, the first opposing wall 43 constitutes the housing mount portion 4. The housing mount portion 4 is provided between the electric wire connection portion 3 and the electrical contact portion 5. The housing mount portion 4 corresponds to “tube portion” described in claims. The first opposing wall 43 corresponds to “outer wall” described in claims.

The first tube portion 41 is provided with an opening portion 4a provided from the first opposing wall 43 to one side wall 44a of the pair of side walls 44a, 44b and penetrating the first opposing wall 43 and one of the side walls 44a.

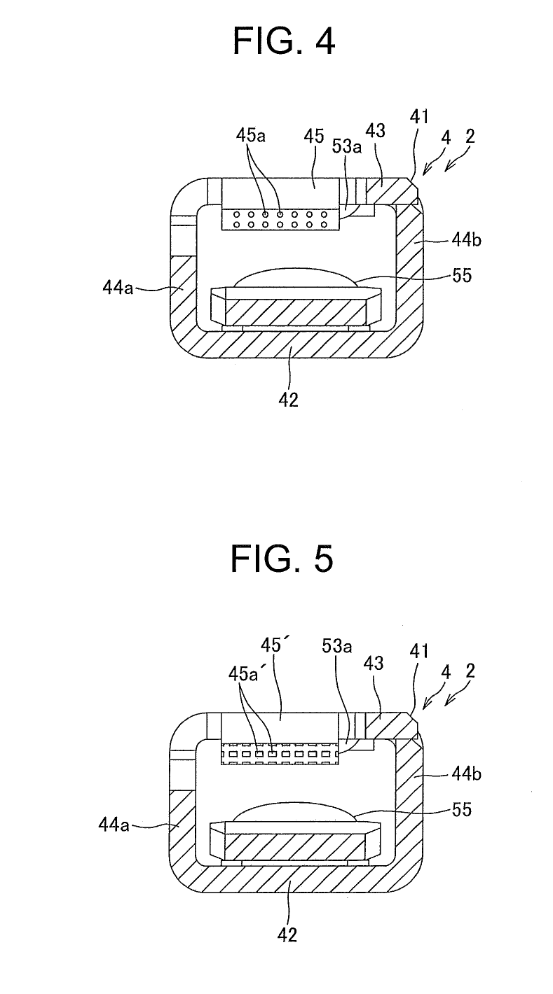

As shown in FIG. 4, the engagement portion 45 is formed by bending a part of the first opposing wall 43 toward an inner side of the first tube portion 41. In other words, the engagement portion 45 is arranged so as to project from an edge of the opening portion 4a adjacent to the electrical contact portion 5 toward the inner side of the first tube portion 41. A plurality of projections 45a is formed on a surface of the engagement portion 45 adjacent to the electric wire connection portion 3. In other words, the plurality of projections 45a is formed on the surface of the engagement portion 45 adjacent to the electric wire connection portion 3 so that the surface of the engagement portion 45 is indented. The projection 45a is formed into a semispherical shape.

The electrical contact portion 5 includes a second tube portion 51 formed into a hollow rectangular column-like shape with a base wall 52 continued to the base wall 42, a second opposing wall 53 continued to the first opposing wall 43 of the housing mount portion 4 and a pair of side walls 54 continued to each of the pair of side walls 44a, 44b of the housing mount portion 4. The electrical contact portion 5 further includes a spring piece 55.

The second tube portion 51 described above includes an insertion opening formed at an end distant from the housing mount portion 4, i.e. one end 2a (shown in FIG. 3) of the terminal fitting 2, and an insert of the mating terminal fitting is inserted from this insertion opening. The second opposing wall 53 of the second tube portion 51 includes a protruding portion 53a formed at an inner face of the second opposing wall 52 and protruding from the inner face of the second opposing wall toward the base wall 52. This protruding portion 53a extends along the longitudinal direction N.

The spring piece 55 described above is attached to an inner face of the base wall 52 forming the second tube portion 51. The spring piece 55 is arranged to push the insert inserted to the inner side of the second tube portion 51 toward the second opposing wall 53.

When inserted into the electrical contact portion 5, the insert of the mating terminal fitting elastically contacts with the protruding portion 53a and the spring piece 55. Thus, the mating terminal fitting and the terminal fitting 2 are electrically connected to each other.

The housing 6 is made of insulating synthetic resin. This housing 6 includes the lance 65 and the plurality of terminal receiving portions 61 arranged to receive the terminal fitting 2 to the inside thereof. In FIG. 1, only one of the plurality of terminal receiving portions 61 is shown, and other terminal receiving portions 61 are not shown.

The terminal receiving portion 61 is formed into a tubular shape extending along the longitudinal direction N and is formed with a bottom wall 62, an upper wall 63 arranged with a space from the bottom wall 62 and a pair of side walls 63 connecting both widthwise edges of the bottom wall 62 and the upper wall 63 to each other. In other words, both ends 6a, 6b of the terminal receiving portion 61 in the longitudinal direction N are in communication with the outside of the housing 6. The above-described terminal fitting 2 is inserted into the terminal receiving portion 61 from the one end 6a toward the other end 6b.

The lance 65 is formed into a rod-like shape. This lance 65 is provided at a central portion of the terminal receiving portion 61 in the longitudinal direction N. One end of the lance 65 in the longitudinal direction N is formed continuous with an inner face of the bottom wall 62, and the other end of the lance 65 is a free end. Furthermore, the lance 65 is slanted in a direction from the bottom wall 62 to the upper wall 63 as it extends from said one end to said other end. In other words, the other end (i.e. the free end) of the lance 65 is extending toward the housing mount portion 4 of the terminal fitting 2. Furthermore, the lance 65 includes an abutting portion 66 provided to the other end of the lance 65 and arranged to abut on the engagement portion 45 of the terminal fitting 2, and a beak portion 67 arranged nearer the bottom wall 62 than the abutting portion 66 and projecting to the one end 6a of the terminal receiving portion 61 compared to the abutting portion 66. When the abutting portion 66 abuts on the engagement portion 45, the beak portion 67 is arranged along an outer surface of the second opposing wall 53 constituting the electrical contact portion 5. Herein, the expression of “terminal fitting 2 (or engagement portion 45) engages with lance 65” means that the abutting portion 66 of the lance 65 abuts on the engagement portion 45 of the terminal fitting 2.

Next, the assembling procedure of the above-described connector 1 is explained.

Firstly, the electrical contact portion 5 of the terminal fitting 2 connected to the end of the electric wire 7 is moved to the terminal receiving portion 61, and the terminal fitting 2 is inserted into the terminal receiving portion 61 from the one end 6a. When the electrical contact portion 5 passes by the lance 65, the electrical contact portion 5 pushes the lance 65 toward the bottom wall 62. Thus, the electrical contact portion 5 moves while elastically deforming the lance 65 toward the bottom wall 62.

Next, once the terminal fitting 2 is inserted into the terminal receiving portion 61 and the electrical contact portion 5 is positioned at the other end 6b of the terminal receiving portion 61, i.e. the terminal fitting 2 is received in the terminal receiving portion 61, then the lance 65 which was elastically deformed is restored to its original position and the abutting portion 66 of the lance 65 is abutted on the engagement portion 45. In other words, the terminal fitting 2 (i.e. the engagement portion 45) is engaged with the lance 65. As a result, the terminal fitting 2 can be prevented from being removed out from the terminal receiving portion 61. Thus, the connector is assembled in a manner described above.

According to the above-described embodiment, the engagement portion 45 is arranged so as to project from the edge of the opening portion 4a toward the inner side of the housing mount portion 4. Thus, the area of contact between the engagement portion 45 and the lance 65 is increased, thereby improving the retention strength of the lance 65 on the terminal fitting 2. Thus, the connector 1 which can increase the retention strength of the lance 65 of the terminal receiving portion 61 on the terminal fitting 2 can be provided.

Furthermore, the engagement portion 45 is formed by bending a part of the first opposing wall 41 which constitutes the housing mount portion 4 toward the inner side of the housing mount portion 4. Thus, the work for forming the terminal fitting 2 can be reduced, thereby reducing the time required to manufacture the connector 1 and improving the product efficiency.

Furthermore, since the surface of the engagement portion 45 is indented, the frictional resistance on the surface of the engagement portion 45 is increased. Thus, the engagement portion 45 is less likely to slidably move with respect to the free end of the lance 65, thereby further improving the retention strength of the lance 65 of the terminal receiving portion 61 on the terminal fitting 2.

In the above-described embodiment, as shown in FIG. 4, the engagement portion 45 has the projection 45a formed on the surface adjacent to the electric wire connection portion 3 and formed into the semispherical shape. Although the projection 45a is formed into the circular shape in the planar view, the present invention is not limited to this, and an engagement portion 45′ may have a projection 45a′ formed on the surface adjacent to the electric wire connection portion 3 and having a cubic shape. In other words, the projection 45a′ may have a rectangular shape in the planar view as long as the engagement portion 45′ has a recess and a projection on the surface adjacent to the electric wire connection portion 3.

Furthermore, in the above-described embodiment, the projection 45a and the projection 45a′ are provided to the surface of the engagement portion 45 and the engagement portion 45′ adjacent to the electric wire connection portion 3. However, the present invention is not limited to this, and the projection 45a and the projection 45a′ may be omitted.

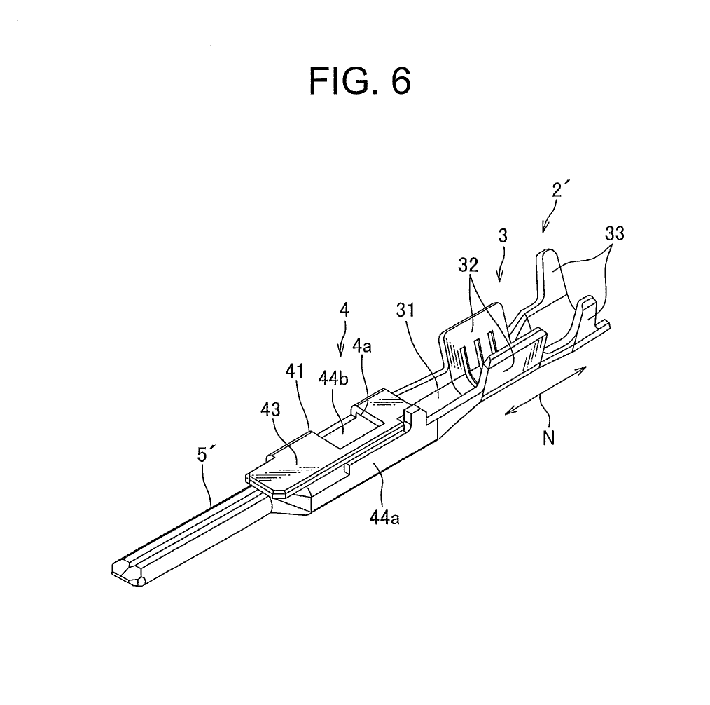

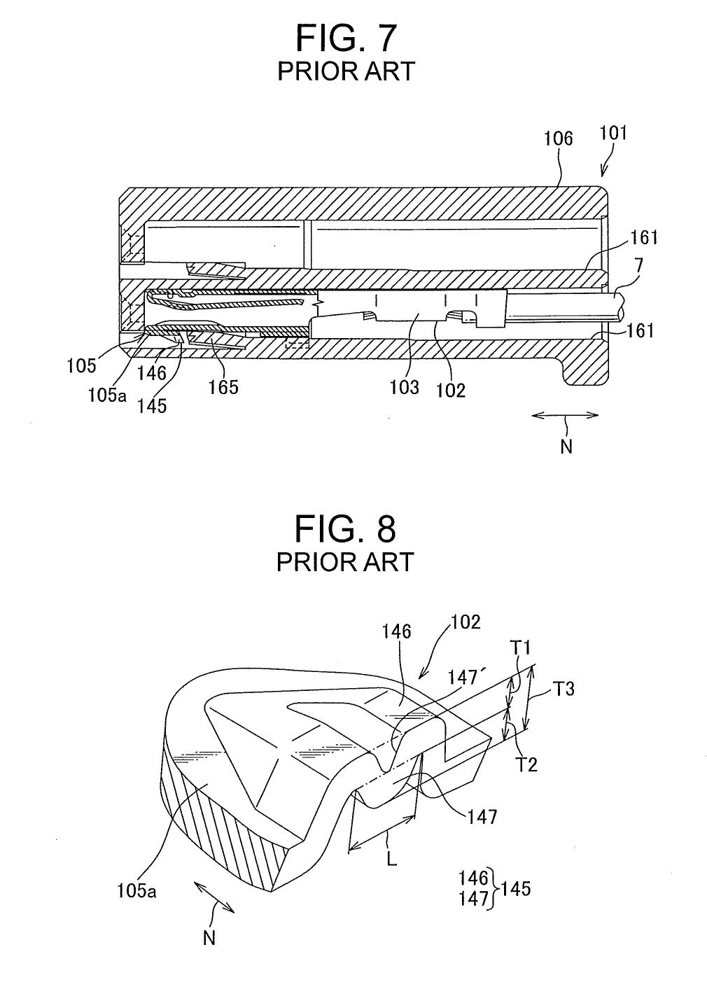

Furthermore, according to the above-describe embodiment, the electrical contact portion 5 includes the second tube portion 51 and the spring piece 55, and thus the terminal fitting 2 is a female-type terminal fitting having the hollow rectangular shape. However, the present invention is not limited to this, and as shown in FIG. 6, there may be provided an electrical contact portion 5′ as an insert provided to a terminal fitting 2′. In FIG. 6, those elements similar to the aforementioned embodiment are indicated by the same reference signs to omit explanation.

The embodiments described herein are only representative embodiment of the present invention, and the present invention is not limited to these. That is, the present invention can be modified in various ways and implemented without departing from the gist of the present invention.

### REFERENCE SIGN LIST

1 connector

2, 2′ terminal fitting

3 electric wire connection portion

4 housing mount portion

5, 5′ electrical contact portion

6 housing

7 electric wire

43 first opposing wall (outer wall)

45 engagement portion

61 terminal receiving portion

65 lance

1. A connector comprising:
a terminal fitting including an electric wire connection portion arranged to be connected to an electric wire, an electrical contact portion arranged to be connected to a mating terminal fitting, and a tube portion provided between the electric wire connection portion and the electrical contact portion; and
a housing including a terminal receiving portion arranged to receive the terminal fitting, wherein the housing is provided with a lance having one end continued to an inner face of the terminal receiving portion and the other end being a free end and extending toward the tube portion of the terminal fitting,
wherein an opening portion is formed at the tube portion,
wherein an engagement portion which engages with the free end of the lance is provided to an edge of the opening portion adjacent to the electrical contact portion, and
wherein the engagement portion is arranged to project from the edge of the opening portion toward an inner side of the tube portion.

2. The connector according to claim 1, wherein the engagement portion is formed by bending a part of an outer wall of the tube portion toward the inner side of the tube portion.

3. The connector according to claim 1, wherein a surface of the engagement portion is indented.

4. The connector according to claim 2, wherein a surface of the engagement portion is indented.
